(19) United States
(12) Patent Application Publication
(10) Pub. No.: US 2007/0293097 A1
(43) Pub. Date: Dec. 20, 2007

(54) Modular plug electrical connector

(75) Inventors: Ralph Sykes Martin, Mount Airy, NC (US); Linda Ellen Bert, Camp Hill, PA (US); Michael Patrick Green, Mechanicsburg, PA (US); Sam Denovich, Harrisburg, PA (US); James Joseph Eberle, Hummelstown, PA (US)

Correspondence Address: Lisa B. Vaccarelli;Tyco Electronics Corporation, Suite 140, 4550 New Linden Hill Road, Wilmington, DE, 19808-2952, US

(73) Assignee: Tyco Electronics Corporation

(21) Appl. No.: 11/454,578

(22) Filed: Jun. 15, 2006

(51) Int. Cl. H01R 9/22

(52) U.S. Cl. 439/713

(57) ABSTRACT

An electrical connector includes a dielectric housing with a mating end and a loading end and having a cavity opening onto the loading end. The loading end is configured to receive wires conveying differential signal pairs. The electrical connector further includes contacts arranged in contact pairs and held in the housing, wherein the contacts have blade portions located at the mating end of the housing and wire terminating portions located at the loading end of the housing. The blade portions extend along different planes that are spaced apart and arranged parallel to one another, and the terminating portions within each of the contact pairs are configured to be joined to wires of a corresponding differential signal pair. The blade portions are arranged in a first pattern, and the terminating portions are arranged in a second pattern that differs from the first pattern. The second pattern is divided into sections, and each section includes the terminating portions of a corresponding contact pair.

### BACKGROUND OF THE INVENTION

This invention relates generally to electrical connectors, and more particularly, to electrical connectors having improved signal performance.

Due to increases in data transmission rates in telecommunications systems, crosstalk has become a significant problem. Crosstalk may be defined as energy which is coupled from one signal line onto a nearby signal line by either capacitive or inductive coupling. This crosstalk results in signal noise which interferes with the purity of the signal being transmitted.

A commonly used telecommunications wiring system is twisted pair wiring wherein pairs of wires are twisted about each other. The wires in a twisted pair carry differential signals and are thus known as signal pairs. Each of the wires in a signal pair carries an equal but opposite signal; that is, the wires carry signals of the same magnitude which are respectively positive and negative. Since these signals are equal but opposite, they generate fields that are equal but opposite. In a twisted pair, these equal and opposite fields cancel each other, thus reducing crosstalk that occurs between one twisted pair and a nearby twisted pair.

Crosstalk in twisted pair wiring systems primarily arises in the electrical connectors which provide an interface between successive runs of cable in a system or an interface with equipment. Industry standard electrical connectors for telecommunications systems include modular plugs and jacks. These connectors have terminals which are spaced closely together and parallel to each other, and this close and parallel arrangement is conducive to crosstalk between nearby lines of different signal pairs. Further, the terminals in a modular plug are dedicated to specific ones of the twisted wires according to a known industry standard such as Telecommunications Industry Association/Electronics Industries TIA-EIA-568. Therefore, ends of the wires must be arranged in a closely spaced parallel sequence in the plug, and these parallel ends are also conducive to crosstalk.

Prior art techniques for reducing crosstalk in these modular plugs have focused primarily on providing compensation inserts within the housings that compensate for the crosstalk between the wires. One such prior art connector is described in commonly owned U.S. Pat. No. 6,113,400, the disclosure of which is hereby incorporated by reference. The compensating insert for the connector includes a dielectric substrate which carries conductive traces, and the traces are arranged to be connected to selected ones of the wires. The wires extend along the top surface of the compensation insert and are terminated to terminals at a mating end of the connector. The traces on the compensation insert are routed on the substrate to provide capacitive coupling between selected signal pairs so as to compensate for crosstalk between the signal pairs, thereby reducing crosstalk in the connector.

Other known plugs include a wire organizer, or load bar, which maintains the wires in an organized array in the plug in order to control crosstalk in the plug. The load bar has upper and lower surfaces with grooves, and each of the grooves receives both wires of a respective signal pair. For example, the wires are un-twisted and laced along the wire organizer. The wires extend the length of the load bar to the pins or contacts used in mating the plug to the jack. This device controls the separation between wires of different signal pairs, thereby controlling crosstalk which would otherwise be uncontrolled between the wires of different signal pairs. Still, the plug may exhibit significant variation in electrical performance due to the variation in the un-twisting, lacing and loading of the wires into the wire organizer. Moreover, at least some plugs follow a standard that requires one of the differential pairs to be split around another pair. The split requires lacing of two wires over the wires of another pair. The repeatability of this lacing is difficult for an operator to perform.

The known plugs struggle to obtain the target crosstalk values as the connectors are not consistently and uniformly manufactured. Rather, the variations in the un-twisting of the wires, the lacing of the wires along the wire organizers, and the connection of the wires to the pins or terminals all lead to a lack of control in the electrical performance of the plugs. There is a need for controlling or creating a predetermined amount of crosstalk in a modular plug and for improving overall crosstalk performance in a communications system.

### BRIEF DESCRIPTION OF THE INVENTION

In one aspect, an electrical connector is provided including a dielectric housing with a mating end and a loading end and having a cavity opening onto the loading end. The loading end is configured to receive wires conveying differential signal pairs. The electrical connector further includes contacts arranged in contact pairs and held in the housing, wherein the contacts have blade portions located at the mating end of the housing and wire terminating portions located at the loading end of the housing. The blade portions extend along different planes that are spaced apart and arranged parallel to one another, and the terminating portions within each of the contact pairs are configured to be joined to wires of a corresponding differential signal pair. The blade portions are arranged in a first pattern, and the terminating portions are arranged in a second pattern that differs from the first pattern. The second pattern is divided into sections, and each section includes the terminating portions of a corresponding contact pair.

Some aspects optionally include terminating portions of a first contact pair that are oriented with respect to one another to extend along a first plane, and terminating portions of a second contact pair that are oriented with respect to one another to extend along a second plane, wherein the first and second planes intersecting one another. Alternative aspects may have the first and second planes are parallel to one another. Optionally, the sections of the second pattern may constitute quadrants into which the loading end is divided, or the sections may include opposed side sections, and at least one of an upper section and a lower section. The blade portions may be arranged in a row. Optionally, the blade portions of a first contact pair may be located immediately adjacent one another and the blade portions of a second contact pair may be located remote from one another and may be separated by the blade portions of the first contact pair.

Other aspects may optionally include dielectric insert mounted into the housing, wherein the insert has slots therein that extend between the mating and loading ends of the housing, and the slots receive the corresponding contacts. Optionally, the contacts may further include a transition portion interconnecting the blade and terminating portions, wherein the slots securely receive the transition portions. The transition portions of a first contact pair may be oriented to extend along a common plane, and the transition portions of a second contact pair may be oriented to extend along a second plane, wherein the first and second planes are parallel to one another. The transition portions of a contact pair may be flared away from one another in a non-parallel geometry.

In another aspect, an electrical connector is provided including a dielectric housing with a mating end and a loading end and having a cavity opening onto the loading end. The loading end is configured to receive wires conveying differential signal pairs. The electrical connector further includes contacts arranged in contact pairs and held in the housing. The contacts have a blade portions located at the mating end of the housing, wire terminating portions located at the loading end of the housing, and transition portions interconnecting the blade portions and the terminating portions. The blade portions extend along different planes that are spaced apart and arranged parallel to one another, and the terminating portions and the transition portions have non-parallel geometries to control the intra-pair electrical interaction of the contacts and to control the inter-pair electrical interaction of the contacts.

### BRIEF DESCRIPTION OF THE DRAWINGS

FIG. 1 is a rear perspective view of a modular plug electrical connector formed in accordance with an exemplary embodiment of the present invention.

FIG. 2 is a front perspective view of an insert and a plurality of contacts for the electrical connector shown in FIG. 1.

FIG. 3 is a top perspective view of the contacts shown in FIG. 2.

FIG. 4 is a bottom perspective view of the contacts shown in FIGS. 4.

FIG. 5 is a side view of the contacts shown in FIGS. 4 and 5.

FIG. 6 is an end view of the insert and contacts shown in FIGS. 2-5.

FIG. 7 is a top view of the insert and contacts shown in FIGS. 2-5.

FIG. 8 is a bottom view of the insert and contacts shown in FIGS. 2-5.

### DETAILED DESCRIPTION OF THE INVENTION

FIG. 1 is a rear perspective view of a modular plug electrical connector 100 formed in accordance with an exemplary embodiment of the present invention. In the illustrated embodiment, the connector 100 is a modular 8-pin connector, such as an RJ-45 plug. The connector 100 is configured for joining with a receptacle or jack (not shown), such as on a wall outlet, a network interface card in a computer, or a hub.

The connector 100 includes a housing 102 extending between a mating end 104 and a loading end 106. The mating end 104 mates with the jack. For example, pins or contacts 108 of the connector 100 are exposed at the mating end 104 and engage corresponding pins or contacts (not shown) of the jack. The arrangement of the contacts 108 at the mating end 104 may be controlled by industry standards, such as by the TIA-968 standard. The loading end 106 of the housing 102 is open to a housing cavity 110. An insert 112 is loaded through the loading end 106 and into the cavity 110. The insert 112 holds the contacts 108. Alternatively, the contacts 108 may be directly received within the housing cavity 110 and secured therein by a different holder. Optionally, the holder may be integrally formed within the housing 102. Alternatively, the holder may be separately provided from the housing 102.

Each of the contacts 108 are attached to communications wires 120 from a cable 122. The communications wires 120 are arranged as differential signal pairs and are attached to, or terminated with, an end of a respective one of the contacts 108. In the illustrated embodiment, eight wires are provided and arranged as four signal pairs. The eight wires are identified as W₁-W₈ and the signal pairs are identified as WP₁-WP₄. The contacts 108 are also arranged as pairs and routed through the insert 112 in a predefined geometry. The contacts are identified as C₁-C₈ and the contact pairs are identified as CP₁-CP₄. Each of the wires W₁-W₈ are terminated to the respective contacts CP₁-C₈.

FIG. 2 is a front perspective view of the insert 112 and the plurality of contacts 108. The insert 112 is fabricated from a non-conductive material, such as plastic, and may be manufactured using a molding process, an overmolding process, a milling process, or the like. The insert 112 is sized and shaped to be securely retained within the cavity 110 (shown in FIG. 1) of the housing 102 (shown in FIG. 1). Keying features, such as shoulders 128, may extend along the outer surface of the insert 112 to properly orient the insert 112 within the housing 102. The insert 112 extends between a mating end 130 and a terminating end 132. The mating end 130 and terminating end 132 of the insert 112 face the mating end 104 (shown in FIG. 1) and loading end 106 (shown in FIG. 1), respectively, of the housing 102. Optionally, the ends 130 or 132 of the insert 112 may be substantially aligned with the ends 104 or 106 of the housing 102.

The insert 112 includes a plurality of slots or channels 134 extending between the mating end 130 and the terminating end 132 of the insert 112. Each slot 134 is sized to receive one of the contacts 108 and arranges the contact 108 in a predetermined position relative to the insert 112 and to each other contact 108. Additionally, the slots 134 position each contact 108 along the mating end 130 for mating with the jack (not shown). The slots 134 may be linear, curvilinear or angled along the length of each slot 134. Additionally, the slots 134 may have a uniform thickness, or alternatively, may have a non-uniform thickness. Each slot 134 may have a different size, shape or orientation, and the slots 134 may extend from more than one surface of the insert 112.

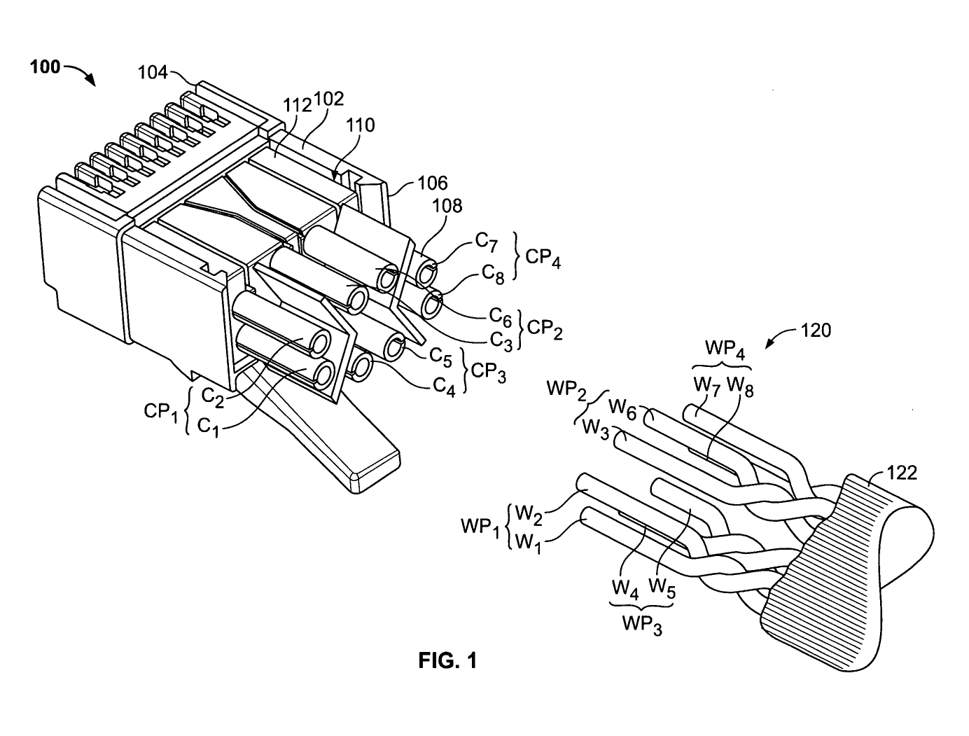

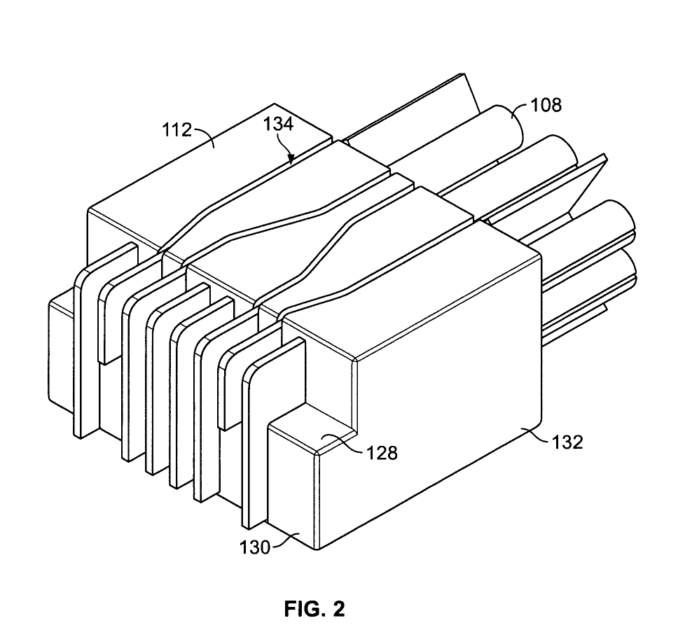

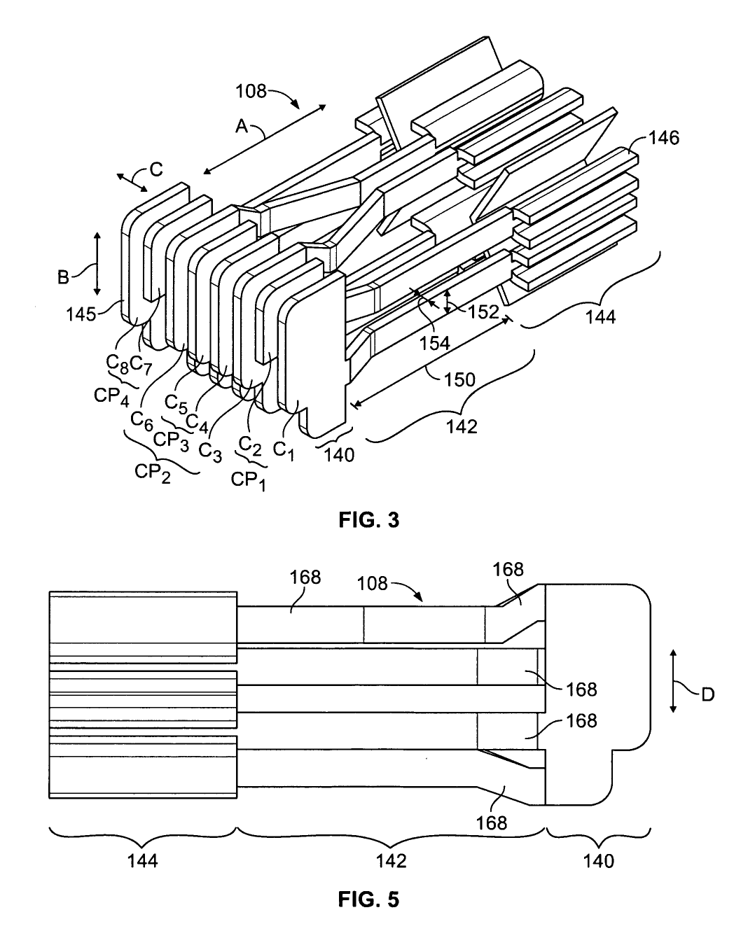

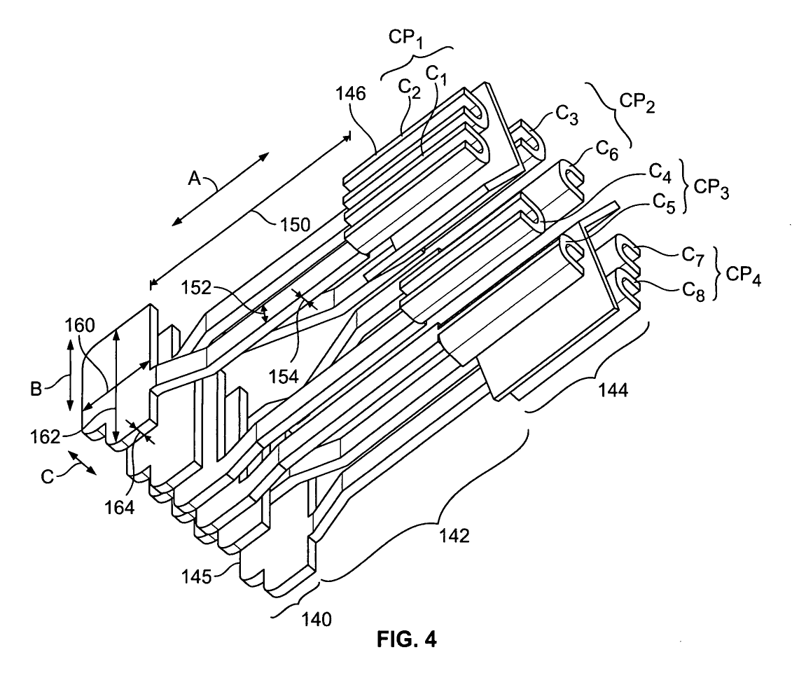

FIGS. 3 and 4 are top and bottom perspective views, respectively, of the contacts 108 with the insert 112 (shown in FIG. 2) removed for clarity. Each of the contacts 108 include a blade portion 140, a transition or connecting portion 142, and a terminating portion 144. The blade portions 140 are arranged at a front of the contacts 108 in a first pattern. For example, in the illustrated embodiment, the blade portions 140 are planar and are arranged as parallel, spaced apart members. Optionally, the blade portions 140 may be substantially equally spaced apart. In some embodiments, the blade portions 140 may be angled with respect to one another. A front end 145 of each blade portion 140 may be substantially aligned with each other front end 145 such that the blade portions 140 are arranged in a single row. Alternatively, adjacent blade portions 140 may be off-set with respect to one another such that the blade portions 140 extend in multiple rows as compared to the mating end 130. The blade portions 140 are positioned proximate the mating end 130 (shown in FIG. 2) of the insert 112 and are configured to mate with the jack (not shown).

The terminating portions 144 are arranged at a rear of the contacts 108 and are positioned proximate the terminating end 132 (shown in FIG. 2) of the insert 112. The communication wires 120 (shown in FIG. 1) are terminated to the terminating portions 144, such as by a crimping process, a soldering process, an insulation displacement connection process, or the like. For example, the terminating portions 144 within each contact pair are joined to wires 120 of a corresponding differential signal pair. In the illustrated embodiment, the terminating portion 144 includes a wire barrel 146 that receives a bare end of one of the wires 120. The wire barrel 146 is crimped to terminate the contact 108 to the wire 120. As indicated above, each of the wires W₁-W₈ are terminated to the respective contacts C₁-C₈, and may be terminated in accordance with industry standards, such as, for example, the TIA-EIA 568.

The terminating portions 144 are arranged in a second pattern that is different than the first pattern of the blade portions 140. For example, the second pattern is non-linear. Optionally, the loading end 106 (shown in FIG. 1) of the connector 100 is divided into multiple sections, and the terminating portions 144 are arranged in a pattern wherein each section includes the terminating portions 144 of one contact pair. In the illustrated embodiment, the sections constitute quadrants, such as an upper quadrant, a lower quadrant, a left quadrant and a right quadrant. In another embodiment, the sections may include an upper section, a lower section, and opposed side sections.

The transition portion 142 of each contact 108 extends between the terminating portion 144 and the blade portion 140 of the contact 108. The transition portions 142 are arranged in a third pattern such that each transition portion 142 has a predetermined geometry with respect to each other transition portion 142 to control both intra-pair electrical interactions and inter-pair electrical interactions of each of the contacts 108, which will be described in more detail below.

As indicated above, each of the contacts 108 are arranged as contact pairs CP₁-CP₄. CP₁ includes contacts C₁ and C₂. CP₂ includes contacts C₃ and C₆. CP₃ includes contacts C₄ and C₅. CP₄ includes contacts C₇ and C₈. Each of the contacts 108 are subject to signal degradation due to interference, crosstalk, return loss and the like due to interactions with the other contacts 108 and possibly with other nearby connectors or devices. Industry standards provide acceptable or target crosstalk values or requirements. Target values may be provided for different tiers of contacts 108 and contact pairs. For example, a first tier may target the highest amount of crosstalk between contact pairs CP₂ and CP₃. A second tier may target a reduced amount of crosstalk between contact pairs CP₁ and CP₂ and between contact pairs CP₃ and CP₄. A third tier may target a reduced amount of crosstalk between contact pairs CP₁ and CP₃ and between contact pairs CP₂ and CP₄. A fourth tier may target the least amount of crosstalk between contact pairs CP₁ and CP₄. Both intra-pair electrical interactions and inter-pair electrical interactions of each of the contacts 108 may effect the target values. The intra-pair electrical interactions are caused by interaction between the contacts 108 within a particular contact pair. The inter-pair electrical interactions are caused by interaction between contacts 108 of one contact pair and the contacts 108 of another contact pair. Both intra-pair electrical interactions and inter-pair electrical interactions are effected by factors including, but not limited to, the size of the contacts 108, the geometry of the contacts 108, the orientation of the contacts 108, the distance of separation between the contacts 108, the presence and type of dielectric material separating the contacts 108, and the presence and placement of shielding between the contacts 108. By controlling these factors, the electrical performance of the connector 100 (shown in FIG. 1), and the signal integrity of the contacts 108 may be managed. Additionally, by controlling these factors, each of the connectors 100 may be manufactured in a uniform manner.

As indicated above, the transition portions 142 of the contacts 108 are arranged in a predefined geometry to control the electrical performance of the connector 100. The size of the contacts 108, the geometry of the contacts 108, the orientation of the contacts 108, the distance of separation between the contacts 108, the presence and type of dielectric material separating the contacts 108, and the presence and placement of shielding between the contacts 108 are all managed to provide target crosstalk values between each of the contacts 108.

Each of the transition portions 142 have a length 150, measured generally along the contact 108 between the blade portion 140 and the terminating portion 144 such as in the direction of arrow A; a height 152, measured generally perpendicular to the length 150 such as in the direction of arrow B; and a width 154, measured generally perpendicular to the length 150 and the height 152 such as in the direction of arrow C. The height 152 and the width 154 define a cross section of the contact 108. By controlling the cross section of the contact 108 along the length 150, the electrical interactions may be controlled. For example, by increasing the size of the contacts 108, the interactions are increased, and by decreasing the size of the contacts 108, the interactions are decreased. By controlling the length 150, the height 152 and/or the width 150 of each the contacts 108, the intra-pair electrical interactions and inter-pair electrical interactions may be managed. Additionally, the height 152 and the width 154 may be varied along the length 150 of the contacts to further control the electrical interactions. For example, portions of the contacts 108 along the length 150 of the contacts 108 are either closer to, or further from, other contacts 108, either the other contact 108 within the contact pair or contacts 108 of other contact pairs.

The shape of the contacts 108 are also managed to control the spacing and amount of separation between the contacts 108. For example, by increasing the spacing between contacts 108, the interactions are decreased, and by decreasing the spacing between the contacts 108, the interactions are increased. In the illustrated embodiments, the spacing between the contacts 108 of at least some of the contact pairs are varied along the length 150 of the contacts 108. For example, the contacts 108 may be angled inwardly toward one another to decrease the spacing between the contacts 108. Optionally, the contacts 108 within a contact pair may be flared away from, or toward, one another such that the contacts 108 have a non-parallel orientation, such as a V-shape arrangement with one another, in at least one axis for a portion of the length 150 of the contacts 108.

Turning to the blade portions 140, the intra-pair electrical interactions and inter-pair electrical interactions may be managed by controlling the sizing or spacing of the blade portions 140. For example, in some plugs, the spacing of the blade portions 140 may be managed to control the electrical interactions between the various contacts 108, however, the spacing between the blade portions 140 may be controlled by industry standards or the particular type of connector. In the illustrated embodiment, C₁ and C₂ are positioned adjacent one another; C₇ and C₈ are positioned adjacent one another; C₄ and C₅ are positioned adjacent one another; and C₃ and C₆ are positioned remote with respect to one another. Optionally, C₄ and C₅ may be positioned between C₃ and C₆.

The blade portions 140 have a length 160, a height 162 and a width 164. The sizing of the blade portions 140 may be controlled by changing at least one of the length 160, the height 162 and the width 164. In the illustrated embodiment, C₂ and C₇ have a reduced size by having a reduced height 162. As such, the interactions between the blade portions of C₂ and C₁ or C₂ and C₃ are reduced. However, the interactions between the blade portions of C₁ and C₃ are increased. Additionally, the interactions between the blade portions of C₇ and C₈ or C₇ and C₆ are reduced. However, the interactions between the blade portions of C₈ and C₆ are increased. In an exemplary embodiment, the length 160 of the blade portions 140 is substantially less than the length 150 of the transition portions 142. In one embodiment, the length 150 is approximately three times the length 160, and as such, the wire termination portions 146 are isolated from the blade portions 140. Additionally, the target crosstalk values may be achieved by controlling the interactions between the contacts 108 along the length 150. In an exemplary embodiment, the height 162 of the blade portions 140 is substantially greater than the height 152 of the transition portions 142. In one embodiment, the height 162 is approximately four times the height 152. In an exemplary embodiment, the width 164 of the blade portions 140 is approximately equal to the width 154 of the transition portions 142.

FIG. 5 is a side view of the contacts 108 illustrating the geometry of the contacts pairs with respect to one another. As discussed above, the spacing of the contacts 108 is important in managing the intra-pair electrical interactions and inter-pair electrical interactions. The contact pairs may be angled toward one another to decrease the spacing therebetween and this increase the interactions. For example, the transition portions 144 may include angled sections 168. The angled sections may be located proximate the blade portions 140 or proximate the terminating portions 144, depending on the target electrical parameters, such as crosstalk or return loss values. The angled sections may be angled vertically, such as in the direction of arrow D, or may be angled horizontally, such as in a direction perpendicular to arrow D.

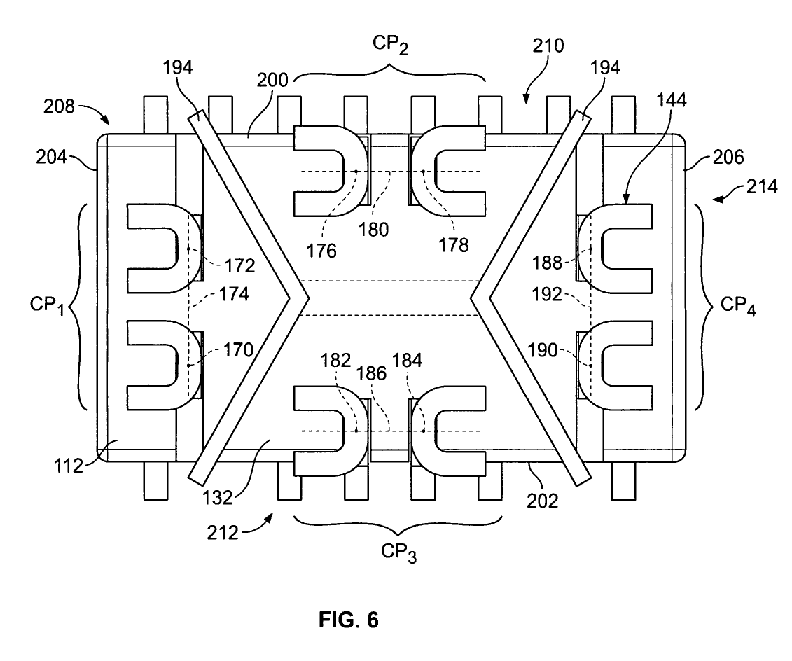

FIG. 6 is an end view of the insert 112 and contacts 108. The intra-pair electrical interactions and inter-pair electrical interactions may be managed by controlling the spacing of the terminating portions 144 and by placing shielding between at least some of the contact pairs. Optionally, the spacing between the terminating portions 144 may be controlled by positioning the contact pairs in different sections of the insert 112. For example, the insert 112 includes an upper surface 200, a lower surface 202, a first outer surface 204 and a second outer surface 206. The first and second outer surfaces 204 and 206 are generally opposed from one another and the upper and lower surfaces 200 and 202 are generally opposed from one another. The sections may be set up in quadrants having CP₁ in a first or outer quadrant 208; CP₂ in a second or upper quadrant 210; CP₃ in a third or lower quadrant 212; and CP₄ in a fourth or outer quadrant 214.

In the illustrated embodiment, the terminating portions 144 of the contacts 108 are arranged in a pattern wherein each of the contact pairs are grouped together as contact pairs CP₁-CP₄ and the contacts 108 of each contact pair are aligned with one another along a common plane. However, the contacts 108 of each contact pair are not aligned with the contacts of other contact pairs. For example, centerline axes 170 and 172 of contacts C₁ and C₂ are aligned along a substantially vertical plane 174, wherein the plane extends generally parallel to first outer surface 204. The centerline axes 176 and 178 of contacts C₃ and C₆ are aligned along a substantially horizontal plane 180, wherein the plane extends generally parallel to upper surface 200. The centerline axes 182 and 184 of contacts C₄ and C₅ are aligned along a substantially horizontal plane 186 that is substantially parallel to the horizontal plane 180 extending through the centerline axes 176 and 178 of contacts C₃ and C₆. Additionally, the horizontal planes 180 and 186 are off-set with respect to one another. The centerline axes 188 and 190 of contacts C₇ and C₈ are aligned along a substantially vertical plane 192 that is substantially parallel to the vertical plane 174 extending through the centerline axes 170 and 172 of contacts C₁ and C₂. Additionally, the vertical planes 174 and 192 are off-set with respect to one another.

In the illustrated embodiment, the terminating portions 144 are arranged in a rectangular box-like configuration. Alternatively, the terminating portions 144 may be arranged in a circular or oval shaped configuration. The terminating portions 144 may be arranged in a staggered configuration wherein the terminating portions 144 are off-set with respect to one another, and with respect to the terminating end 132 of the insert 112. For example, when the transition portions 142 (shown in FIG. 3) have different lengths 150 (shown in FIG. 3), the depth of the terminating portions 140 may be controlled. In each of the alternatives, the spacing between each of the contacts 108 may be managed more efficiently as compared to a connector having the wires 120 (shown in FIG. 1) attached in a linear configuration or a laced configuration wherein one of the pairs of wires 120 are laid over another of the pairs of wires 120. Additionally, the terminating portions 144 provide a consistent geometry at the back end of the connector 100, as compared to the linear or laced configurations, leading to better repeatability and consistency in electrical performance for each connector 100. The terminating portions 144 provide a more natural mating layout for the wires 120, as compared to the linear or laced configurations, as the various terminating portions 144 arrange the connections for each differential pair in different quadrants. Additionally, the natural layout of the terminating portions 144 allow less un-twisting of the wires 120, as compared to the linear or laced configurations, leading to better electrical performance and less assembly error.

As described above, the presence and placement of shielding between the contacts 108 controls the electrical performance of the connector 100 (shown in FIG. 1) and the signal integrity of the contacts 108. In the illustrated embodiment, shield members 194 are positioned between the terminating portions 144 of the contact pairs. The shield members 194 may be positioned between the contacts 108 of a contact pair to further increase the electrical performance of the connector 100. Additionally, shield members 194 may be positioned between transition portions 142 and/or blade portions 140 to further increase the electrical performance of the connector 100. Shield members 194 may also be placed around the outer portions of the contacts 108 to shield the contacts 108 from crosstalk with other connectors or devices.

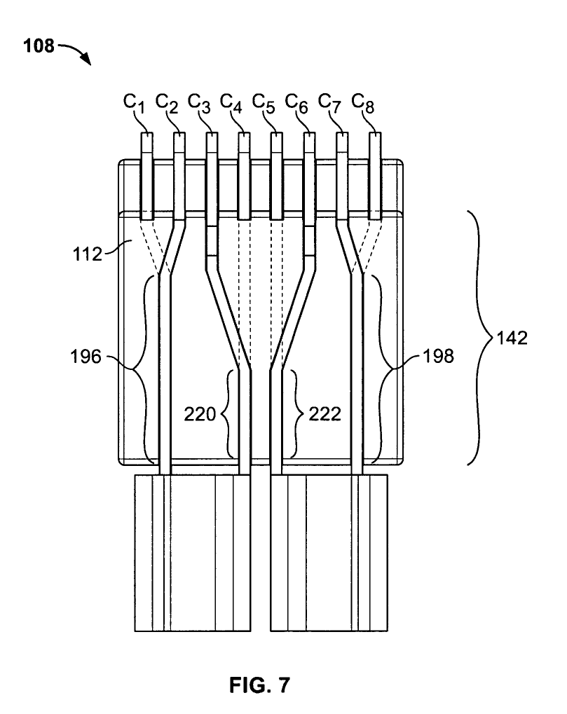

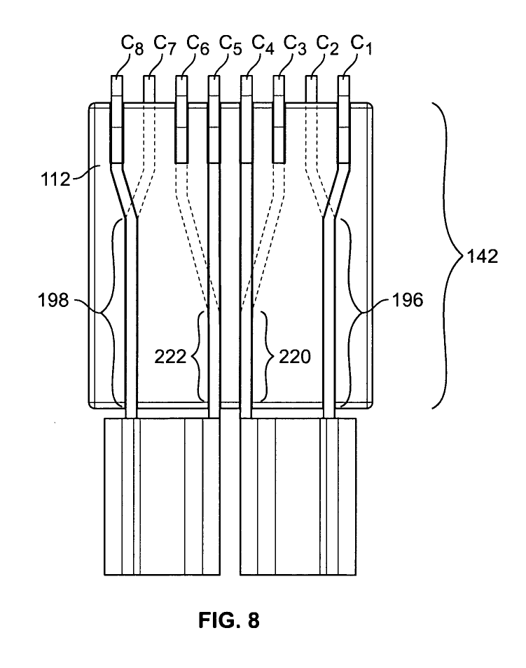

FIGS. 7 and 8 are top and bottom views, respectively, of the insert 112 and contacts 108. As described above, the presence and type of dielectric material separating the contacts 108 controls the electrical performance of the connector 100 (shown in FIG. 1) and the signal integrity of the contacts 108. The insert 112 is fabricated from a plastic material and functions as a dielectric. The composition of the insert material may vary throughout the insert 112, and thus the interaction of the contacts 108 may be managed by controlling the material type. Additionally, air pockets or voids (not shown) may be provided in the insert 112 to vary the type of material between some of the contacts 108. As such, the interaction of the contacts 108 may be managed by placing air pockets in the insert 112 between the contacts 108.

FIGS. 7 and 8 further illustrate the geometry and interaction of the transition portions 142 of the contacts 108. The contacts C₁ and C₂ include an overlap portion 196 to increase the interaction therebetween by decreasing the spacing between the contacts 108. The length of the overlap is selected to manage the interaction. Similarly, contacts C₇ and C₈ include an overlap portion 198; contacts C₃ and C₄ include an overlap section 220; and contacts C₅ and C₆ include an overlap section 222.

A modular eight pin connector 100 is thus provided having eight contacts 108 arranged in contact pairs and held in a housing 102. The contacts 108 include blade portions 140 that interface with a mating jack. The contacts 108 also include terminating portions 144 that are coupled to wires 120 and transition portions 142 that extend between the terminating portions 144 and the blade portions 140. The contacts 108 are arranged as contact pairs and have a predefined geometry used to manage both intra-pair electrical interactions and inter-pair electrical interactions. For example, the blade portions 140 are arranged in a first pattern and the terminating portions 144 are arranged in a second, different pattern. The patterns affect many factors that control the electrical performance of the connector 100, such as the size of the contacts 108, the geometry of the contacts 108, the orientation of the contacts 108, the distance of separation between the contacts 108, the presence and type of dielectric material separating the contacts 108, and the presence and placement of shielding between the contacts 108. By controlling these factors, the electrical performance of the connector 100 (shown in FIG. 1), and the signal integrity of the contacts 108 may be managed. Moreover, by controlling these factors using contacts 108 having a predetermined geometry and orientation, the assembly problems associated with known connectors having the wires laced from the cable to a flat board for engaging the contacts, and lacing the wires across one another as the wires are un-twisted, is reduced. As a result, each of the connectors 100 may be manufactured in a uniform, consistent manner.

While the invention has been described in terms of various specific embodiments, those skilled in the art will recognize that the invention can be practiced with modification within the spirit and scope of the claims.

What is claimed is:

1. An electrical connector, comprising:
a dielectric housing with a mating end and a loading end and having a cavity opening onto the loading end, the loading end being configured to receive wires conveying differential signal pairs; and
contacts arranged in contact pairs and held in the housing, the contacts having blade portions located at the mating end of the housing and having wire terminating portions located at the loading end of the housing, the blade portions extend along different planes that are spaced apart and arranged parallel to one another, and the terminating portions within each of the contact pairs being configured to be joined to wires of a corresponding differential signal pair, the blade portions being arranged in a first pattern, the terminating portions being arranged in a second pattern that differs from the first pattern, the second pattern being divided into sections, each section including the terminating portions of a corresponding contact pair.

2. The electrical connector of claim 1, wherein the sections constitute quadrants into which the loading end is divided.

3. The electrical connector of claim 1, wherein the sections include opposed side sections, and at least one of an upper section and a lower section.

4. The electrical connector of claim 1, wherein the terminating portions of a first contact pair are oriented with respect to one another to extend along a first plane, the terminating portions of a second contact pair are oriented with respect to one another to extend along a second plane, the first and second planes intersecting one another.

5. The electrical connector of claim 1, wherein the terminating portions of a first contact pair are oriented with respect to one another to extend along a first plane, the terminating portions of a second contact pair are oriented with respect to one another to extend along a second plane, the first and second planes are parallel to one another.

6. The electrical connector of claim 1, wherein the blade portions are arranged in a row.

7. The electrical connector of claim 1, wherein each of the contacts further includes a transition portion interconnecting the blade and terminating portions, wherein the geometry of the terminating portions, the blade portions and the transition portions control the intra-pair electrical interaction and the inter-pair electrical interaction of the contacts.

8. The electrical connector of claim 1, further comprising a dielectric holder within the housing, the holder having slots therein that extend between the mating and loading ends of the housing, the slots receiving the corresponding contacts.

9. The electrical connector of claim 1, wherein each of the contacts further includes a transition portion interconnecting the blade and terminating portions, said electrical connector further comprising a dielectric insert mounted in the housing, the insert including slots that securely receive the transition portions.

10. The electrical connector of claim 1, wherein each of the contacts further includes a transition portion interconnecting the blade and terminating portions, the transition portions of a first contact pair are oriented to extend along a common plane, the transition portions of a second contact pair are oriented to extend along a second plane, the first and second planes parallel to one another.

11. The electrical connector of claim 1, wherein each of the contacts further includes a transition portion interconnecting the blade and terminating portions, the transition portions of a first contact pair are flared away from one another in a V-shape.

12. The electrical connector of claim 1, wherein the blade portions of a first contact pair are located immediately adjacent one another and the blade portions of a second contact pair are located remote from one another and are separated by the blade portions of the first contact pair.

13. An electrical connector comprising:
a dielectric housing with a mating end and a loading end and having a cavity opening onto the loading end, the loading end being configured to receive wires conveying differential signal pairs; and
contacts arranged in contact pairs and held in the housing, the contacts having blade portions located at the mating end of the housing, having wire terminating portions located at the loading end of the housing, and having transition portions interconnecting the blade portions and the terminating portions, wherein the blade portions extend along different planes that are spaced apart and arranged parallel to one another, and the terminating portions and the transition portions have non-parallel geometries to control the intra-pair electrical interaction of the contacts and to control the inter-pair electrical interaction of the contacts.

14. The electrical connector of claim 13, wherein the geometry of the terminating portions, the blade portions and the transition portions control the intra-pair electrical interaction and the inter-pair electrical interaction by controlling the spacing between each of the contacts to control the signal integrity between each of the contacts.

15. The electrical connector of claim 13, wherein the geometry of the terminating portions, the blade portions and the transition portions control the intra-pair electrical interaction and the inter-pair electrical interaction by controlling at least one of a length, a width, and a cross-section of the contacts to control the signal integrity between each of the contacts.

16. The electrical connector of claim 13, the terminating portions being arranged in a pattern that divides the loading end into sections, each section including the terminating portions of a corresponding contact pair wherein the sections constitute quadrants.

17. The electrical connector of claim 13, wherein the terminating portions of a first contact pair are oriented with respect to one another to extend along a first plane, the terminating portions of a second contact pair are oriented with respect to one another to extend along a second plane, the first and second planes intersecting one another.

18. The electrical connector of claim 13, wherein the blade portions are arranged in a row.

19. The electrical connector of claim 13, further comprising a dielectric holder within the housing, the holder having slots therein that extend between the mating and loading ends of the housing, the slots receiving the corresponding contacts.

20. The electrical connector of claim 13, wherein the blade portions of a first contact pair are located immediately adjacent one another and the blade portions of a second contact pair are located remote from one another and are separated by the blade portions of the first contact pair.
